(19) United States
(12) Patent Application Publication
(10) Pub. No.: US 2010/0209719 A1
(43) Pub. Date: Aug. 19, 2010

(54) RESIDUE-FREE, COAT-FORMING, AQUEOUS SEALING SYSTEM FOR METAL SURFACES, BASED ON SILANE

(75) Inventors: Bjoern Borup, Frankfurt (DE); Burkhard Standke, Loerrach (DE); Christian Wassmer, Hausen (DE); Martin Nader, Bad Nauheim (DE); Christian Junker, Neu-Isenburg (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: Evonik Degussa GmbH, Essen (DE)

(21) Appl. No.: 12/678,299

(22) PCT Filed: Sep. 17, 2008
(86) PCT No.: PCT/EP08/62361

§ 371 Date: Mar. 16, 2010

(30) Foreign Application Priority Data
Sep. 21, 2007 (DE) 10 2007 045 186.7

(51) Int. Cl. B32B 15/08; C08L 83/04; B05D 5/00

(52) U.S. Cl. 428/447; 524/588; 525/477; 427/399

(57) ABSTRACT

The invention relates to a composition for coating metal surfaces, containing water-soluble, substantially fully hydrolyzed polysiloxanes with amino-functional groups and vicinal dihydroxyalkyl-functional and/or epoxy-functional groups, a method for the production thereof, the use of said composition for coating metal surfaces, and parts, especially calipers, which are treated with said composition.

The invention relates to a composition for coating metallic surfaces, comprising water-soluble, substantially fully hydrolyzed polysiloxanes having amino-functional groups and vicinal dihydroxyalkyl-functional and/or epoxy-functional groups, to a process for its preparation, to the use of the composition for treating metallic surfaces, and to components treated therewith, more particularly brake calipers.

Components given a metallic coating, especially components coated with zinc or zinc alloys, are frequently passivated and subsequently sealed. Sealing compositions employed include waterglass, organic compounds, such as acrylates, polyurethanes or else epoxides, and also mixtures thereof with titanic esters, titanium chelates or else silanes. Silanes are typically used in mixtures with titanic esters in organic solvent mixtures, as described in DE 41 38 218 A1.

DE 198 14 605 A1 relates to an aqueous sealing composition based on silane derivatives in the presence of colloidal silica and/or colloidal silicate.

DE 10 2004 037 045 A1 likewise discloses an aqueous composition, based on the reaction of glycidyloxypropylalkoxysilanes, an aqueous silica sol, an organic acid, and a crosslinking agent.

Disadvantageous features of said sealing systems is their lack of chemical stability in the face of aggressive solvents such as glycols, or else the formation of abrasive residues after the silane systems have cured. The use of organic solvents is undesirable for a variety of reasons. These include the VOC directive, an increased fire risk, and health risks associated with the processing of solvent-containing sealing systems, owing more particularly to their increased volatility, when for the purpose of crosslinking, for example, it is necessary to operate at elevated temperatures.

The lack of chemical stability of organic-based systems had hitherto ruled out their use for components which are operated in the stated aggressive solvents. One example of such components are brake parts that are operated in glycol-based systems.

Powdery residues as well, however, owing to use of systems based on waterglasses or colloidal silicas, such as silica sols, are problematic in the subsequent use of the components which are sealed using them, and reduce the lifetime of such components. Moreover, sealing systems based on waterglasses lack any so-called self-healing effect.

The problem addressed was that of developing a sealing system for metallic surfaces, based on aqueous silane systems, that does not form particulate residues and that has an increased chemical resistance. The system ought, moreover, to be free from organic solvents.

This problem is solved in accordance with the claims.

The sealing system of the invention for coating metallic surfaces is a composition which comprises water-soluble, substantially fully hydrolyzed polysiloxanes having amino-functional groups and vicinal dihydroxyalkyl-functional and/or epoxy-functional groups, and water, optionally comprises acid and/or optionally auxiliaries, with each silicon in the polysiloxanes carrying at least one functional group; more particularly, the composition is substantially free from organic solvents. Particularly preferred compositions are based on substantially fully hydrolyzed polysiloxanes having amino-functional groups and vicinal dihydroxy-functional groups and/or groups derived therefrom, water, optionally acid and/or at least one auxiliary, with each silicon in the polysiloxanes carrying at least one functional group, and the composition being substantially free from organic solvents. More particularly the composition is free from fluoro-functional siloxanes. The polysiloxanes of the aqueous composition of the invention are preferably free from alkoxy groups and are present in the form of functionalized siloxanes with silanol groups. A composition is regarded as substantially free from organic solvents, which also includes alcohols, if the solvent content is less than 5%, preferably less than 1%, more preferably less than 0.5% or even less than 0.1% by weight. Dihydroxyalkyl-functional groups are taken to include dihydroxyalkyl ether-functional groups.

It is assumed that the polysiloxanes of the invention are able to react or crosslink via the amino-functional groups with a metallic surface or else with a metallic passivating coat; in particular, the amino-functional polysiloxanes are able to react with oxidic chromium(III) compounds. Particularly advantageous is the crosslinking of diamine-functional compounds, such as N-2-aminoethyl-3-aminopropyl-functional silanes. Furthermore, for example, the polysiloxanes may enter via the silanol functions into a condensation reaction with corresponding hydroxy functions on a metallic surface or on a passivating coat.

In the inventive embodiment the polysiloxanes in the composition have amino-functional groups of the general formula Ia

R²_{b}NH_{(2-b)}—[(CH₂)_{c}—NR²*_{d}H_{(1-d)}]ₑ—(CH₂)_{f}— (Ia)

where b=0, 1 oder 2, 1≦c≦6, d=0 or 1, 0≦e≦6, more particularly e=0 or 1, 1≦f≦6, and R² and/or R²* are a benzyl or vinyl group; in particular the polysiloxanes, as further functional groups, have linear, branched and/or cyclic alkyl groups having 1 to 16 C atoms or alkenyl groups, vinyl groups for example, preferred alkyl groups being methyl, ethyl, propyl and/or n-octyl, and/or the polysiloxanes, as vicinal dihydroxyalkyl-functional or epoxy-functional groups, have glycidyloxypropyl, 3-(2,3-dihydroxypropoxy)propyl, 2-(3,4-epoxycyclohexyl)ethyl or 2-(3,4-dihydroxycyclohexyl)ethyl groups. The composition of the invention comprises polysiloxanes which are based on the reaction of siloxanes of N-2-aminoethyl-3-aminopropyl groups and methyl groups on the silicon and siloxanes having glycidyloxypropyl groups and/or, more particularly, having 3-(2,3-dihydroxypropoxy)propyl groups. The amino-functional siloxanes may be obtained through a reaction of N-2-aminoethyl-3-aminopropyltrimethoxysilane and methyltriethoxysilane in the presence of water and, optionally, an acid, and subsequent removal of the alcohols.

Other amino-functional siloxanes are based, for example, on the reaction of 3-amino-propyltriethoxysilane, 3-aminopropylmethyldiethoxysilane or on the reaction of 3-aminopropyltriethoxysilane with an alkyl-functional alkoxysilane, such as methyltri-ethoxysilane, or on the reaction of aminopropyltriethoxysilane with a vinyl-functional alkoxysilane in the presence of water and optionally an acid, and subsequent removal of the alcohols.

Accordingly a siloxane substituted by 3-glycidyloxypropyl groups and/or more particularly by 3-(2,3-dihydroxypropoxy)propyl groups can be obtained by hydrolysis and condensation of 3-glycidyloxypropyltrimethoxysilanes or 3-glycidyloxypropyltriethoxysilanes in the presence of a water/acid mixture, with subsequent removal of the alcohol.

The amino-functional and 3-(2,3-dihydroxypropoxy)propyl-functional and/or 3-glycidyloxypropyl-functional, water-soluble siloxanes that are formed may be reacted with one another to give the composition of the invention comprising water-soluble polysiloxanes.

Preferred compositions are based on the reaction of the Hydrosils 2776 (cocondensate of diaminoalkoxysilane and methylalkoxysilane), Hydrosil 2781 (cocondensate of aminoalkoxysilane and vinylalkoxysilane), Hydrosil 2627 (cocondensate of aminoalkoxysilane and alkylalkoxysilane) and/or Hydrosil 1151 (product of aminopropyltrialkoxysilane) with the Hydrosils 2926 (product of epoxyalkoxysilane) and/or 2759 (product of epoxyalkoxysilane with glycol as additive) from Degussa. These products and condensates may be prepared by reacting the corresponding silanes in a suitable solvent, in the presence of water and optionally in the presence of an acid, and subsequently removing the hydrolysis of alcohol and any organic solvent present, as is described by way of example in EP 0953591 A1, whose disclosure content in its entirety is made part of the content of the present patent specification.

Preferred compositions, moreover, have a pH of greater than 8, more particularly between 8 to 10, more preferably between 8.5 to 10, the pH more particularly not being set via the addition of alkali metal compounds or alkaline earth metal compounds. The composition is therefore free from alkali metal compounds and alkaline earth metal compounds. It is preferred, furthermore, for the compositions to have a particular polysiloxane content which is particularly favorable for application to metallic surfaces. The reason is that only with such a polysiloxane content is it possible to realize the formation of clear, crack-free and/or particle-free coatings. This polysiloxane content of the composition is 0.5% to 20%, more particularly 1.5% to 10%, preferably 2.5% to 5% by weight.

As already mentioned at the outset, particulate residues in coatings restrict the lifetime of the components coated therewith in their subsequent application. It is therefore particularly preferred for the composition comprising polysiloxanes having amino-functional groups and vicinal dihydroxyalkyl-functional and/or epoxy-functional groups to be free from colloids and/or silicates. A composition is considered free from colloids if it is free from silica sols, i.e., free from colloidal, amorphous silicon dioxide. More particularly the composition is free from colloids comprising particles in the range from 400 to 1000 nm; more particularly the particles in the composition are smaller than 35 nm and/or are between 0.5 to 35 nm, preferably between 0.5 and 25 nm. The particle size distribution may be determined conventionally by means of laser diffraction (Coulter LS particle size measuring instrument).

The compositions take the form of a clear liquid. Moreover, the resulting compositions in the mixture according to the invention, more particularly having the corresponding polysiloxanes contents, can be processed and are stable at room temperature for months. Where, for example, a metallic component treated with a conventional metal pretreatment solution is immersed into a bath composition based on purely amino-functionally substituted siloxanes, precipitates are formed in the composition within hours, and render the composition very largely unusable. When glycidyloxypropylalkoxysilanes are used alone in a dilute aqueous mixture, a significantly lower degree of corrosion protection is afforded than with the mixture according to the invention.

The composition according to the invention was developed in order to form a particularly chemically resistant coat as a form of corrosion protection on metallic surfaces, passivations, especially Cr(III)-containing passivations, more preferably with Cr(III) oxides. For components which must be operated in aggressive solvents, such as brake fluids, chemical resistance is of particular interest in order to improve the lifetime of the components. A further factor is that on components which are subjected to severe friction or else grinding processes, a coating soon acquires cracks or is destroyed completely. The corrosion protection of metallic components, ferrous components for example, is generally accomplished by coating the base metal, such as iron, for example, with a coating metal, such as zinc, for example, or with a zinc alloy, such as Zn—Fe, Zn—Co or Zn—Ni alloys, for example, followed by application of a passivation. Passivation is generally accomplished with cobalt (Co)-containing Cr(III) oxides, possibly containing dissolved zinc from the coating method. Subsequently, for the purpose of sealing, this coat system has the composition according to the invention applied to it in order to form, via chemical crosslinking of the polysiloxanes with the chromium(III)-containing passivating coat, more preferably with Cr(III) oxides, which may also contain dissolved Co compounds and Zn compounds, a chemically and mechanically extremely resistant coat.

A feature of the polysiloxanes in the composition according to the invention is that they are based on condensed amino-functional siloxanes and vicinal dihydroxyalkyl-functional siloxanes; the amines may also have reacted with the diols in the mixture. These polysiloxanes react or crosslink in turn for example via the amino function with the metallic surface and/or via the silanol groups with the hydroxyl groups with condensation reactions and with formation of a strong chemical crosslinking, and with formation of a coat with the metallic surfaces, i.e., the polysiloxanes of the invention crosslink to form a coat with the metallic surfaces. In this context it is particularly preferred if the polysiloxanes crosslink with Cr(III) compounds, more preferably with Cr(III) oxides. More particularly the compounds based on amino-functional siloxanes react with an oxidic chromium(III) compound. In this way it is possible to obtain a chemically and mechanically extremely resistant coating which affords lasting corrosion protection. Specifically, the protection mechanism lies in the formation of an organo-silicatic conversion coat on the passivation. In this context it is particularly preferred for this coat to be free from particulate residues. Particulate residues are considered to be colloids, namely silica sols (SiO₂), and/or inorganic silicates, such as lithium polysilicate, particularly if the particulate solids thereof have dimensions in the range from 400 to 1000 nm, more particularly well above 40 nm.

The composition may also comprise further additives or auxiliaries. For instance, additions of colorants, friction modifiers, wetting agents, defoamers, buffers or organic binders are possible.

The invention also provides a process for preparing a composition according to the invention. The process comprises the reaction of substantially fully hydrolyzed, amino-functional siloxanes with epoxy-functional and/or vicinal dihydroxyalkyl-functional siloxanes, the amino-functional siloxanes being based on the reaction of A mol of aminoalkylalkoxysilanes of the general formula I

R²_{b}NH_{(2-b)}—[(CH₂)_{c}—NR²*_{d}H_{(1-d)}]ₑ—(CH₂)_{f}—Si(R¹*)ₐ(OR¹*)₃₋ₐ (I)

where a ═0 or 1, b=0, 1 or 2, 1≦c≦6, d=0 or 1, 0≦e≦6, more particularly e=0 or 1, 1≦f≦6, and R² and/or R²* are a benzyl or vinyl group, and where R¹ and/or R¹* are a methyl, ethyl, propyl or isopropyl group, optionally with B mol of alkylalkoxysilanes and/or alkenylalkoxysilanes of the general formula II

R⁴—Si(OR³)₃ (II)

where R⁴ is a linear, branched or cyclic alkyl group having 1 to 16 C atoms or an alkenyl group, more particularly a vinyl group, and R³ is a methyl, ethyl, propyl or isopropyl group, in the molar ratio of 0<A/B≦2, in the presence of water and optionally in the presence of an acid, more particularly in the alkaline range, at a pH of less than 11—preferably there may be a pH between 8 to 11, more particularly between 8.5 to 10.0- and with particular preference the pH is between 9.0 and 10.0, and the removal of alcohol that is already present or is formed; and where the vicinal dihydroxy-functional and/or epoxy-functional siloxanes are based on the reaction of alkoxysilanes substituted by glycidyloxypropyl, 3-(2,3-dihydroxypropoxy)propyl, 2-(3,4-epoxycyclohexyl)ethyl and/or 2-(3,4-dihydroxycyclohexyl)ethyl groups, of the general formula III

R⁵—Si(R⁶)_{g}(OR⁶*)_{3-g} (III)

where g=0 or 1 and R⁵ is a 3-glycidyloxypropyl, 3-(2,3-dihydroxypropoxy)propyl, 2-(3,4-dihydroxycyclohexyl)ethyl or 2-(3,4-epoxycyclohexy)ethyl group, R⁶ is a methyl or ethyl group, and R⁶* is a methyl, ethyl, propyl or isopropyl group, in the presence of a water/acid mixture, more particularly at a pH of 1 to 8, and the removal of the alcohol which is already present or is formed. The alcohol in the context of the two stated reactions is removed preferably down to a level of less than 5%, preferably less than 1%, more preferably less than 0.5% or even less than 0.1% by weight. In one preferred embodiment the ratio (molar ratio) of amino-functional siloxanes to vicinal dihydroxyalkyl-functional and/or epoxy-functional siloxanes is 1:4 to 4:1, more preferably 1:2 to 2:1. It is advantageous to set the pH of the composition at a level of more than 8, more particularly to a level between 8.5 to 10.

Further provided by the invention is a composition obtainable through the reaction of substantially fully hydrolyzed, amino-functional siloxanes with vicinal dihydroxyalkyl-functional and/or epoxy-functional siloxanes, in accordance with the processes specified above, and having more particularly a polysiloxane content of 0.5% to 20%, preferably of 1.5% to 10%, more preferably of 2.5% to 5% by weight and/or a pH in the range from 8 to 11, preferably between 8.5 to 10. Prior to crosslinking, these compositions are clear, and after crosslinking they form clear, chemically resistant coatings which exhibit no cracks or particulate residues. Moreover, in the mixture according to the invention, more particularly with the corresponding polysiloxane contents, the compositions obtained are stable, not least, in particular, during application as a bath composition for the wetting of metallic components. In contrast, customary amino-functional compositions which are not based on the mixture according to the invention generally form a sediment within just hours after being brought into contact with correspondingly pretreated metallic components, and render the composition unusable. It is assumed that the formation of this sediment originates from a reaction with entrained contaminants or residues of a metal pretreatment solution which, as an inevitable consequence of the process, are incorporated through the metallic components into a corresponding bath composition.

A further subject of the invention relates to a composition comprising water-soluble, substantially fully hydrolyzed polysiloxanes, the polysiloxanes of the general formula IV being derived from the silanes of general formulae I and III and optionally II,

(R¹*O)[(R⁷)Si(R¹)ₐ(OR¹*)₁₋ₐO]ₕ[(R⁴)Si(OR³)O]ᵢ[(R⁸)Si(R⁶)_{g}(OR⁶*)_{1-g}O]ⱼ(R⁶*).(HX)ₖ (IV)

where R¹*, R³ and/or R⁶* are hydrogen, R¹ is a methyl, ethyl, propyl or isopropyl group, R⁴ independently at each occurrence is a linear, branched or cyclic alkyl group having 1 to 16 C atoms and/or an alkenyl group, a vinyl group for example, R⁶ is methyl or ethyl, R⁸ is derived from R⁵, where R⁵ is a 3-glycidyloxypropyl, 3-(2,3-dihydroxypropoxy)propyl, 2-(3,4-epoxycyclohexyl)ethyl or 2-(3,4-dihydroxycyclohexyl)ethyl group, and R⁷ is derived from the amino-functional group of the general formula Ia

R²_{b}NH_{(2-b)}—[(CH₂)_{c}—NR²*_{d}H_{(1-d)}]ₑ—(CH₂)_{f}— (Ia)

with b=0, 1 or 2, 1≦c≦6, d=0 or 1, 0≦e≦6, 1≦f≦6, and where R² and/or R²* are a benzyl or vinyl group, the amino-functional group corresponding more particularly to a 3-aminopropyl group, with e=0, or to an N-2-aminoethyl-3-aminopropyl group, with e=1, where a ═0 or 1, g=0 or 1, 1≦h, 0≦i, 1≦j, and 0≦k, more particularly 1≦i, HX is an acid, with X being an inorganic or organic acid radical, and the composition being substantially free from organic solvents. A composition is considered substantially free from organic solvents, such as alcohols, when its solvent content is less than 5%, preferably less than 1%, more preferably less than 0.5% or even less than 0.1% by weight. As an acid it is possible to use customary organic or inorganic acids such as formic acid, acetic acid, nitric acid, hydrochloric acid, phosphoric acid or sulfuric acid.

Additionally claimed is a kit comprising a sealing system composed of a first component and a second component, the first component comprising water-soluble, substantially fully hydrolyzed polysiloxanes of the general formula IVa, derived from the silane of the general formula I and optionally II

(R¹*O)[(R⁷)Si(R¹)ₐ(OR¹*)₁₋ₐO]ₕ[(R⁴)Si(OR³)O]ᵢ(R³).(HX)ₖ (IVa)

where R¹* and/or R³ is hydrogen, R¹ is a methyl, ethyl, propyl or isopropyl group, and R⁴ independently at each occurrence is a linear, branched or cyclic alkyl group having 1 to 16 C atoms and/or an alkenyl group, more particularly a vinyl group, and R⁷ is derived from the amino-functional group Ia

R²_{b}NH_{(2-b)}—[(CH₂)_{c}—NR²*_{d}H_{(1-d)}]ₑ—(CH₂)_{f}— (Ia)

with b=0, 1 or 2, 1≦c≦6, d=0 or 1, 0≦e≦6, 1≦f≦6, and where R² and/or R²* are a benzyl or vinyl group, the amino-functional group corresponding more particularly to a 3-aminopropyl group, with e=0, or to an N-2-aminoethyl-3-aminopropyl group, with e=1, where a=0 or 1, 1≦h, 0≦i, more particularly 1≦i, and 0≦k, more preferably k=0, HX is an acid, with X being an inorganic or organic acid radical, and the composition being substantially free from organic solvents—particularly preference is given to polysiloxane cocondensates based on the reaction of N-2-aminoethyl-3-aminopropyltrialkoxysilanes and methyltrialkoxysilanes with 1≦h and 1≦i, and
the second component comprises water-soluble, substantially fully hydrolyzed polysiloxanes of the general formula IVb, derived from the silane of the general formula III

(R⁶*O)[R⁵—Si(R⁶)_{g}(OR⁶*)_{1-g}O]ⱼ(R⁶*) (IVb)

where R⁶* is hydrogen and R⁶ is methyl or ethyl, and R⁵ is derived from a 3-glycidyloxypropyl, 3-(2,3-dihydroxypropoxy)propyl, 2-(3,4-epoxycyclohexyl)ethyl or 2-(3,4-dihydroxycyclohexyl)ethyl group, where g=0 or 1, 1≦j, and the composition is substantially free from organic solvents. Particular preference is given to polysiloxanes based on the reaction of 3-glycidyloxypropyl- and/or 3-(2,3-dihydroxypropoxy)propyl-trialkoxysilanes with 1≦j.

The compositions of the invention can be utilized for treating, modifying or coating metallic surfaces, more particularly surfaces which exhibit metal oxides and/or metal hydroxides.

Further claimed is a method of producing metallic components, more particularly brake calipers, by treating or modifying them with a composition according to the invention. For example, the component or a part thereof is wetted with the composition and, with subsequent crosslinking of the polysiloxane, curing and formation of a coat or a film on the surface of the component take place. The component or a part thereof is wetted by means of customary application methods, such as dipping, spraying, spin dip coating, etc. The temperature at which wetting takes place is not critical, and wetting may take place both at room temperature and at elevated temperatures. It is preferred to operate in the range from 5 to 100° C., preferably at 15 to 60° C. The subsequent curing or crosslinking of the polysiloxanes may take place at 40 to 150° C., preferably at 50 to 150° C. For the drying and/or curing it is possible to utilize customary air-circulation or vacuum systems.

The invention additionally provides components having metallic surfaces, more preferably components having surfaces comprising Cr(III) compounds, such as Cr(III) oxides, more particularly brake components, such as brake calipers, more particularly those of disk brakes. The stated brake calipers are typically installed in common automobiles. They are preferably obtained by the method described above. These components, and more preferably brake calipers, more particularly having surfaces comprising Cr(III) compounds, Cr(III) oxides, are distinguished by the fact that they have a coating based on the crosslinking of polysiloxanes with amino-functional groups and vicinal dihydroxyalkyl-functional and/or epoxy-functional groups. These surfaces may also, furthermore, comprise cobalt and/or zinc. The components of the invention, more particularly brake calipers, are operated, when used in the manner intended, in aggressive brake fluids, based on petroleum derivatives, silicones and/or glycols, more particularly DOT 3 or DOT 4 brake fluids (DOT=Department of Transportation, US standards for brake fluids). DOT 4, for example, may be based on the following composition: glycol ether, glycol ether borate, polyglycols, and inhibitors, which may more particularly be triethylene glycol monobutyl ether, diethylene glycol, diethylene glycol monohexyl ether, diethylene glycol monobutyl ether, diethylene glycol monomethyl ether, and aliphatic amines.

The invention is illustrated below by the following examples.

### EXAMPLES

### Example 1

200 g of Dynasylan® HYDROSIL 2926 are introduced and 3600 g of water (distilled) are added. This is followed by the addition with stirring of 200 g of Dynasylan® HYDROSIL 2776. After a standing time of an hour, the product obtained is ready for use.

### Example 2

100 g of Dynasylan® HYDROSIL 2627 and 300 g of Dynasylan® HYDROSIL 2926 are mixed and 3600 g of distilled water are added. After a standing time of an hour, the product is suitable for use.

Working examples for application to brake calipers:

### Example 3

A brake caliper is immersed into the passivating solution set out under example 2, and after about 2 minutes in the immersion bath is withdrawn from the bath. The excess fraction of passivating solution is removed by centrifugation. The brake caliper is subsequently dried at 120° C. The layer formed from the passivation solution remains clear even after drying, and there are no deposits or particulate residues on the brake caliper.

### Example 4

A brake caliper is immersed into the passivating solution set out under example 1 and after about 2 minutes in the immersion bath is removed from it. Excess passivating solution is removed by drip drying. Thereafter the brake part is dried at approximately 60° C. The coat on the brake part, obtained from the passivating solution, is clear even after drying, and there are no deposits present.

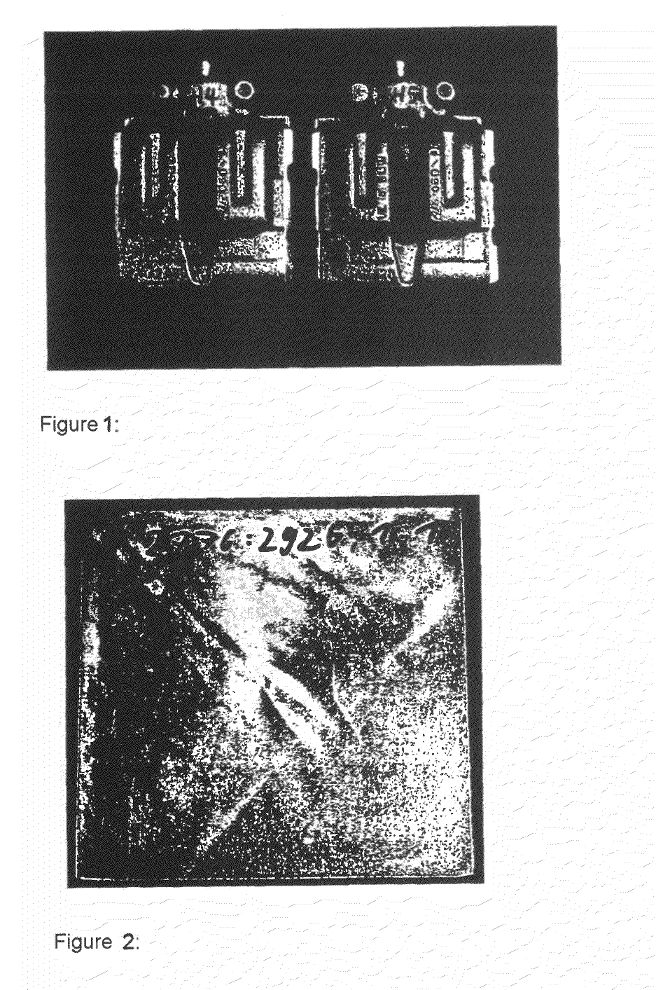

FIG. 1 shows two brake calipers with coatings according to examples 3 and 4. These coatings have no particulate residues at all after crosslinking on the metallic surface of the components. The coatings are clear, run-free and non-flaking.

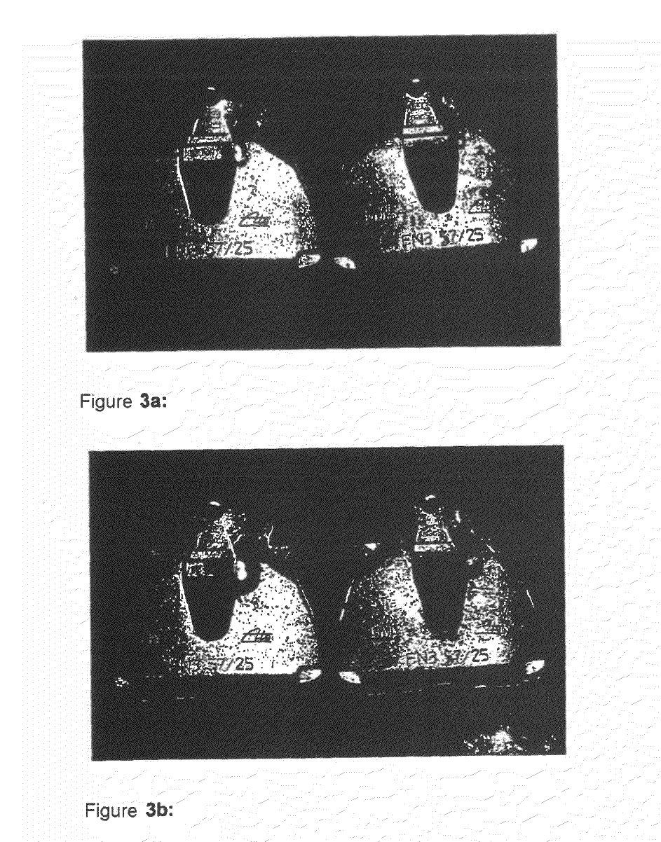

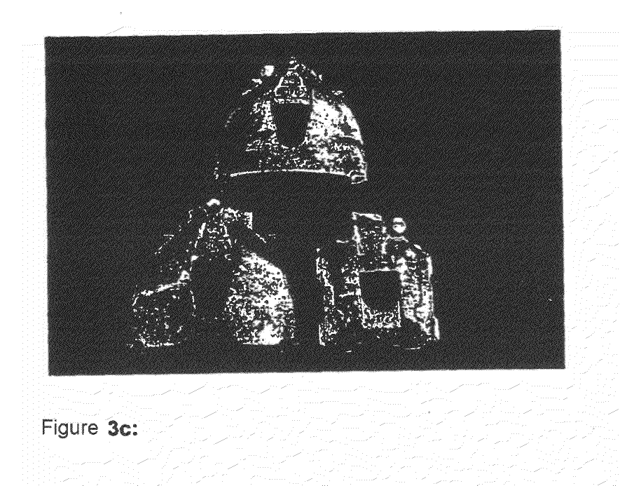

FIG. 2 shows a metal panel after 120 hours of salt-spray testing in accordance with DIN EN ISO 9227 NSS, the panel having been coated with the composition according to example 1. Even after preliminary damage by stonechipping with subsequent salt-spray testing, this panel shows no coating corrosion after 216 hours. FIGS. 3a, 3b, and 3c show brake calipers with a coating according to examples 3 and 4, which, even after a 744-hour-long salt spray test in accordance with DIN EN ISO 92277 NSS exhibit no red rust formation at all.

The invention is illustrated below with reference to the exemplary embodiments shown in the figures.

FIG. 1 shows the visual appearance of coated brake calipers.

FIG. 2 shows a coated metal panel with a polysiloxane mixture based on a 1:1 mixture of Dynasylan® HYDROSIL 2776 and Dynasylan® HYDROSIL 2926 after 120 hours of salt-spray testing.

FIG. 3a shows coated brake calipers after 216 hours of salt-spray testing.

FIG. 3b shows coated brake calipers after 480 hours of salt-spray testing.

FIG. 3c shows coated brake calipers after 744 hours of salt-spray testing.

1. A composition for coating metallic surfaces, comprising water-soluble, substantially fully hydrolyzed polysiloxanes having amino-functional groups and vicinal dihydroxyalkyl-functional and/or epoxy-functional groups, water, optionally comprising acid and/or optionally auxiliaries, and being substantially free from organic solvents, with each silicon in the polysiloxanes carrying at least one functional group.

2. The composition of claim 1,
wherein the polysiloxanes have amino-functional groups of the general formula Ia
R²_{b}NH_{(2-b)}—[(CH₂)_{c}—NR²*_{d}H_{(1-d)}]ₑ—(CH₂)_{f}— (Ia)
in which b=0, 1 or 2; 1≦c≦6; d=0 or 1; 0≦e≦6, 1≦f≦6, and R² and/or R²* are a benzyl or vinyl group, and
said polysiloxanes have glycidyloxypropyl, 3-(2,3-dihydroxypropoxy)propyl, epoxycyclohexyl)-ethyl or 2-(3,4-dihydroxycyclohexyl)ethyl groups as vicinal dihydroxyalkyl-functional or epoxy-functional groups, and
optionally, as further functional groups, have linear, branched and/or cyclic alkyl groups having 1 to 16 C atoms and/or alkenyl groups.

3. The composition of claim 1,
wherein the pH is greater than 8.

4. The composition of claim 1,
wherein the polysiloxane content is 0.5 to 20% by weight.

5. The composition of claim 1,
wherein it is free from colloids and/or silicates.

6. The composition of claim 1,
wherein the polysiloxanes crosslink with metallic surfaces to form a coat.

7. The composition of claim 6,
wherein the polysiloxanes crosslink with Cr(III) compounds.

8. The composition of claim 6,
wherein the coat formed is free from particulate residues.

9. A process for preparing a composition of claim 1, comprising the reaction of substantially fully hydrolyzed, amino-functional siloxanes with vicinal dihydroxyalkyl-functional and/or epoxy-functional siloxanes, the amino-functional siloxanes being based on the reaction of
A mol of aminoalkylalkoxysilanes of the general formula I
R²_{b}NH_{(2-b)}—[(CH₂)_{c}—NR²*_{d}H_{(1-d)}]ₑ—(CH₂)_{f}—Si(R¹*)ₐ(OR¹*)₃₋ₐ (I)
in which a=0 or 1, b=0, 1 or 2, 1≦c≦6, d=0 or 1, 0≦e≦6, 1≦f≦6, and R² and/or R²* are a benzyl or vinyl group, and where R¹ and/or R¹* are a methyl, ethyl, propyl or isopropyl group,
optionally with B mol of alkylalkoxysilanes and/or alkenylalkoxysilanes of the general formula II
R⁴—Si(OR³)₃ (II)
in which R⁴ is a linear, branched or cyclic alkyl group having 1 to 16 C atoms or an alkenyl group, and R³ is a methyl, ethyl, propyl or isopropyl group, in the molar ratio of 0<A/B≦2,
in the presence of water and optionally in the presence of an acid, and the removal of the alcohol that is already present or is formed;
and where the vicinal dihydroxy-functional and/or epoxy-functional siloxanes are based on the reaction of alkoxysilanes substituted by glycidyloxypropyl groups or 2-(3,4-epoxycyclohexyl)ethyl groups, of the general formula III
R⁵—Si(R⁶)_{g}(OR⁶*)_{3-g} (III)
in which g=0 or 1 and R⁵ is a glycidyloxypropyl, 3-(2,3-dihydroxypropoxy)-propyl, 2-(3,4-epoxycyclohexyl)ethyl or 2-(3,4-dihydroxycyclohexyl)ethyl group, R⁶ is a methyl or ethyl group, and R⁶* is a methyl, ethyl, propyl or isopropyl group,
in the presence of a water/acid mixture, and the removal of the alcohol which is already present or is formed.

10. The process of claim 9,
wherein the ratio of amino-functional siloxanes to vicinal dihydroxyalkyl-functional and/or epoxy-functional siloxanes is 1:4 to 4:1.

11. The process of claim 9,
wherein the pH is greater than 8.

12. The process of claim 9,
wherein the pH is between 8.5 to 10.

13. A composition obtained according to claim 9.

14. The composition of claim 1, comprising water-soluble, substantially fully hydrolyzed polysiloxanes,
wherein it comprises polysiloxanes of the general formula IV, derived from the silanes of general formulae I and III and optionally II
(R¹*O)[(R⁷)Si(R¹)ₐ(OR¹*)₁₋ₐO]ₕ[(R⁴)Si(OR³)O]ᵢ[(R⁸)Si(R⁶)_{g}(OR⁶*)_{1-g}O]ⱼ(R⁶*).(HX)ₖ (IV)
in which R¹*, R³ and/or R⁶* are hydrogen, R¹ is a methyl, ethyl, propyl or isopropyl group, R⁴ independently at each occurrence is a linear, branched or cyclic alkyl group having 1 to 16 C atoms and/or an alkenyl group, R⁶ is methyl or ethyl,
R⁸ is derived from R⁵, where R⁵ is a glycidyloxypropyl, 3-(2,3-dihydroxypropoxy)propyl, 2-(3,4-epoxycyclohexyl)ethyl or 2-(3,4-dihydroxycyclohexyl)ethyl group, and R⁷ is derived from the amino-functional group (R²_{b}NH_{(2-b)}—[(CH₂)_{c}—NR²*_{d}H_{(1-d)}]_{c}—(CH₂)ᵣ—, with b=0, 1 or 2, 1≦c≦6, d=0 or 1, 0≦e≦6, 1≦f≦6, and where R² and/or R²* are a benzyl or vinyl group,
where in formula IV a=0 or 1, g=0 or 1, 1≦h, 0≦i, 1≦j, and 0≦k, HX is an acid, with X being an inorganic or organic acid radical, and the composition being substantially free from organic solvents.

15. A kit comprising a sealing system composed of a first component and a second component, the first component comprising water-soluble, substantially fully hydrolyzed polysiloxanes of the general formula IVa, derived from the silane of the general formula I and optionally the silane of the formula II
(R¹*O)[(R⁷)Si(R¹)ₐ(OR¹*)₁₋ₐO]ₕ[(R⁴)Si(OR³)O]ᵢ(R³).(HX)ₖ (IVa)
in which R¹* and/or R³ is hydrogen, R¹ is a methyl, ethyl, propyl or isopropyl group, and R⁴ independently at each occurrence is a linear, branched or cyclic alkyl group having 1 to 16 C atoms and/or an alkenyl group, and R⁷ is derived from the amino-functional group Ia
R²_{b}NH_{(2-b)}—[(CH₂)_{c}—NR²*_{d}H_{(1-d)}]ₑ—(CH₂)_{f}— (Ia)
with b=0, 1 or 2, 1≦c≦6, d=0 or 1, 0≦e≦6, 1≦f≦6, and where R² and/or R²* are a benzyl or vinyl group,
where in formula IVa a ═0 or 1, 1≦h, 0≦i, and 0≦k, HX is an acid, with X being an inorganic or organic acid radical, and the composition being substantially free from organic solvents,
and the second component comprises water-soluble, substantially fully hydrolyzed polysiloxanes of the general formula IVb, derived from the silane of the general formula III
(R⁶*O)[R⁵—Si(R⁶)_{g}(OR⁶*)_{1-g}O]ⱼR⁶* (IVb)
in which R⁶* is hydrogen and R⁶ is methyl or ethyl, and R⁵ is derived from a glycidyloxypropyl, 3-(2,3-dihydroxypropoxy)propyl, 2-(3,4-epoxycyclohexyl)-ethyl or 2-(3,4-dihydroxycyclohexyl)ethyl group,
where in formula IVb g=0 or 1, j≧1, and the composition is substantially free from organic solvents.

16. A composition for treating, modifying or coating metallic surfaces comprising the composition of claim 1.

17. The composition of claim 16,
wherein the metallic surface comprises Cr(III) compounds.

18. A method of producing metallic components by treating or modifying them with a composition of claim 1.

19. The method of claim 18,
wherein the components have Cr(III) compounds on their surface.

20. The method of claim 18,
wherein the components are brake calipers.

21. A brake caliper obtained according to the method of claim 18.

22. A component having a metallic surface,
wherein it has a coating based on the crosslinking of polysiloxanes having amino-functional groups and/or vicinal dihydroxyalkyl-functional and/or epoxy-functional groups.

23. The component of claim 22,
wherein the coating is crosslinked with a surface comprising Cr(III) compounds.

24. The component of claim 22,
wherein it is operated in an aggressive fluid.

25. The component of claim 24,
wherein the fluid comprises petroleum derivatives, silicones, glycols, DOT 3, DOT 4 and/or mixtures of these fluids.

26. A brake caliper
wherein it has a coating based on the crosslinking of polysiloxanes having amino-functional groups and vicinal dihydroxyalkyl-functional and/or epoxy-functional groups.

27. The brake caliper of claim 26,
wherein the coating is crosslinked with a surface comprising Cr(III) compounds.
